(19) United States
(12) Patent Application Publication
(10) Pub. No.: US 2011/0157360 A1
(43) Pub. Date: Jun. 30, 2011

(54) SURVEILLANCE SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/727,246

(22) Filed: Mar. 19, 2010

(30) Foreign Application Priority Data
Dec. 30, 2009 (CN) 200910312707.5

(51) Int. Cl. H04N 7/18; G06T 15/00

(52) U.S. Cl. 348/143; 345/419

(57) ABSTRACT

A surveillance system includes a time-of-flight (TOF) camera and a processing unit. The TOF camera captures a scene to obtain an image of the scene and distance data between a number of points in the scene and the TOF camera. The processing unit builds a three-dimensional (3D) model of the scene according to the image of the scene and the distance data between the points in the scene and the TOF camera, and compares a standard 3D model with the 3D model from the 3D model building module, to determine whether the two 3D models are the same. When the two 3D models are different, the processing unit notices that there is anomalous event occurring in the scene.

### BACKGROUND

1. Technical Field

The present disclosure relates to a surveillance system and a method for the surveillance system.

2. Description of Related Art

For identifying whether a person is a person of special interest, conventional surveillance systems may include cameras to capture the person's image. However, many factors, such as intensity of light, may influence performance of the cameras. As a result, the conventional surveillance systems are not accurate enough.

### BRIEF DESCRIPTION OF THE DRAWINGS

FIG. 1 is a schematic block diagram of an exemplary embodiment of a surveillance system including a storage system.

FIG. 2 is a schematic block diagram of the storage system of FIG. 1.

FIGS. 3A-3B are schematic diagrams of a scene being monitored by the surveillance system in FIG. 1.

FIG. 4 is a flowchart of an exemplary embodiment of a surveillance method.

### DETAILED DESCRIPTION

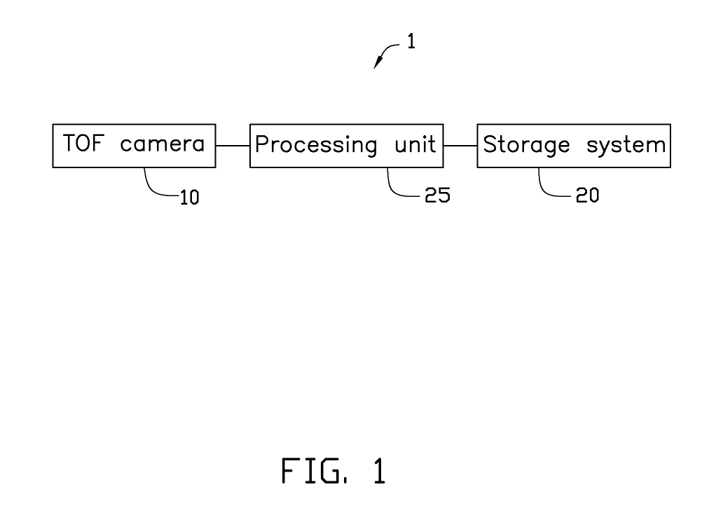

Referring to FIG. 1, an exemplary embodiment of a surveillance system 1 includes a time-of-flight (TOF) camera 10, a processing unit 25, and a storage system 20. The TOF camera 10 captures a scene to get an image, and distance data between every point in the scene and the TOF camera 10. The storage system 20 and the processing unit 25 receive the image and the distance data to obtain a three-dimensional (3D) model of the scene, for determining whether an anomalous event is occurring in the scene.

The TOF camera 10 is a camera system that creates distance data between every point in the scene and the TOF camera 10. When the TOF camera 10 surveys the scene, the TOF camera 10 sends electrical signals throughout the scene. The electrical signals bounce back to the TOF camera 10 when they meet an object, such as a wall, in the scene. As a result, the distance data can be obtained according to time differences between the TOF camera 10, sending, and receiving the electrical signals.

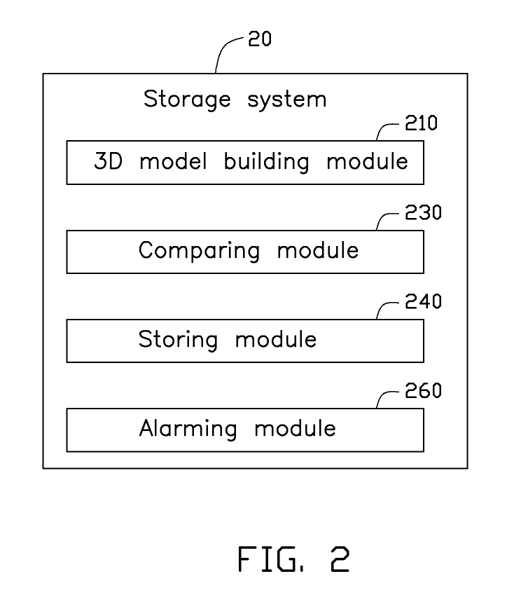

Referring to FIG. 2, the storage system 20 includes a 3D model module 210, a comparing module 230, a storage module 240, and an alarm module 260. The 3D model module 210, the comparing module 230, and the alarm module 260 may include one or more computerized instructions that are executed by the processing unit 25.

The 3D model module 210 builds a 3D model of the scene according to the image of the scene and the distance data between every point in the scene and the TOF camera 10. In the embodiment, according to the distance data between every point in the scene and the TOF camera 10, every point in the scene has coordinates relative to the TOF camera 10. The 3D model module 210 can obtain a curved surface according to the coordinates of every point in the image. The curved surface can be regarded as the 3D model of the scene.

The storage module 240 stores a standard 3D model of the scene in advance when there is no anomalous event occurring in the scene. It is noteworthy that the standard 3D model of the scene, when there is no anomalous event occurring can be obtained by the 3D model module 210.

The comparing module 230 compares the standard 3D model stored in the storing module 240 with the 3D model from the 3D model module 210, to determine whether the two 3D models are the same. In the embodiment, it is noteworthy that the comparing module 230 compares the two curved surfaces, to determine whether the two 3D models are the same. If the two 3D models are the same, there is no anomalous event occurring in the scene. If the two 3D models are not the same, the comparing module 230 obtains coordinates of the points of the 3D model from the 3D model module 210 which are different from the 3D model stored in the storing module 240. The points of the 3D model from the 3D model module 210 are the positions where the anomalous events occur.

The alarm module 260 sends notice to users that there are anomalous events occurring in the scene when the two 3D models are different.

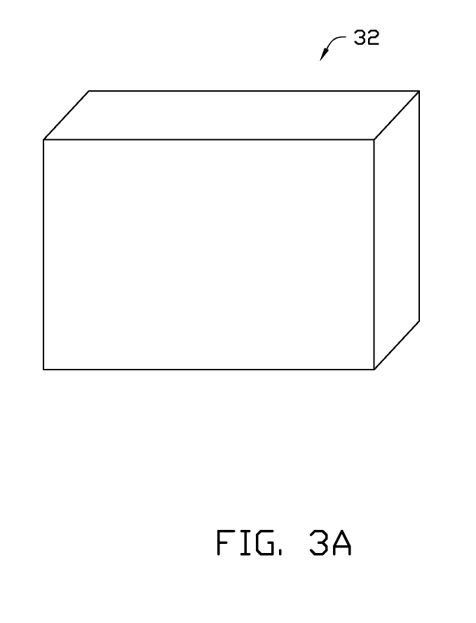

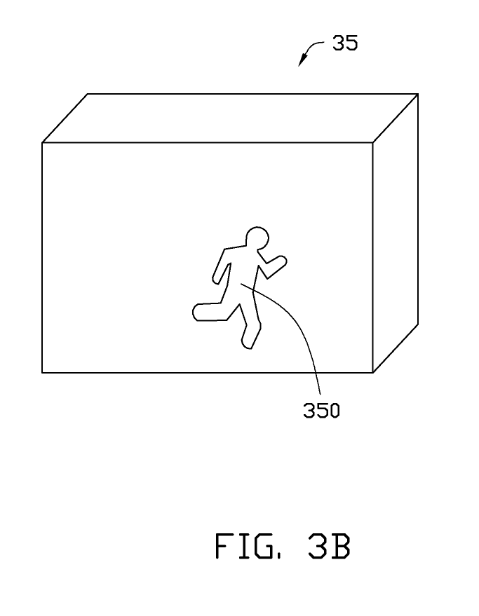

Referring to FIG. 3A, in one embodiment, the TOF camera 10 captures a room when there is no anomalous event occurring in the room to obtain a first image and first distance data between every point in the room and the TOF camera 10. The 3D model module 210 obtains a standard 3D model 32 according to the first image and the first distance data. The standard 3D model 32 is stored in the storing module 240.

The moment, a person 350 enters the room. The TOF camera 10 captures the room to obtain a second image and second distance data between every point in the room and the TOF camera 10 at this moment. The 3D model module 210 obtains a 3D model 35 according to the second image and the second distance data.

The comparing module 230 compares the two 3D models 32 and 35, to determine the standard 3D model 32 is different from the 3D model 35. The comparing module 230 obtains coordinates of the points of the 3D model 35 from the 3D model module 210 which are different from coordinates of the standard 3D model 32 stored in the storing module 240. The different points of the 3D model 35 from the 3D model module 210 are the positions where the anomalous events occur. As a result, the alarm module 260 sends notice to the users that there is anomalous event occurring in the room.

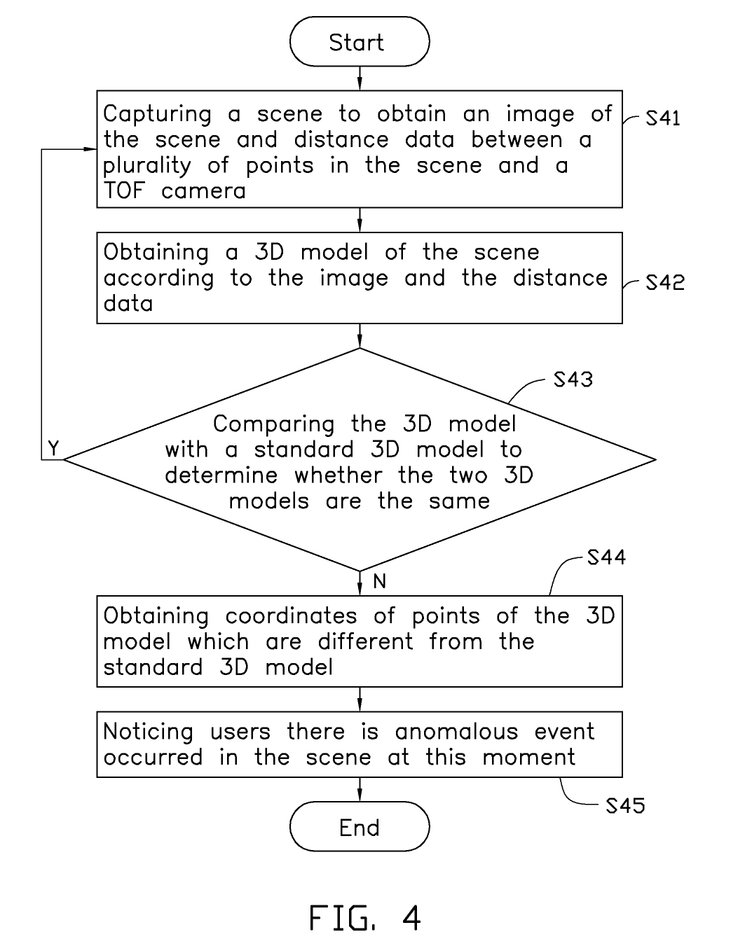

Referring to FIG. 4, an exemplary embodiment of a surveilling method includes the following steps.

In step S41, the TOF camera 10 captures the scene to obtain the image of the scene and the distance data between every point in the scene and the TOF camera 10.

In step S42, the 3D model module 210 obtains the 3D model of the scene according to the image and the distance data between every point in the scene and the TOF camera 10.

In step S43, the comparing module 230 compares the 3D model from the 3D model module 210 with a standard 3D model stored in the storage module 240, to determine whether the two 3D models are the same. In the embodiment, the TOF camera 10 captures the scene when there is no anomalous event occurring in the scene to obtain a first image and first distance data between every point in the scene and the TOF camera 10. The 3D model module 210 obtains the standard 3D model 32 according to the first image and the first distance data. If the two 3D models are the same, the flow goes to the step S1. If the two 3D models are different, the flow goes to the step S4.

In step S44, the comparing module 230 obtains coordinates of the points of the 3D model from the 3D model module 210 which are different from the standard 3D model stored in the storing module 240. The different points of the 3D model from the 3D model module 210 are the positions where the anomalous event occurs.

In step S45, the alarm module 260 sends notice to the users that there is anomalous event occurring in the room at this moment.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A surveillance system comprising:
a time-of-flight (TOF) camera to capture a scene to obtain an image of the scene and distance data between a plurality of points in the scene and the TOF camera;
a processing unit connected to the TOF camera; and
a storage system connected to the processing unit and storing a plurality of modules to be executed by the processing unit, wherein the plurality of modules comprises:
a three-dimensional (3D) model module to build a 3D model of the scene according to the image of the scene and the distance data between the plurality of points in the scene and the TOF camera;
a comparing module to compare a standard 3D model of the scene with the 3D model from the 3D model module, to determine whether the two 3D models are the same; and
an alarm module to notice that there is anomalous event occurring in the scene upon the condition that the two 3D models are different.

2. The surveillance system of claim 1, wherein the storage system further comprises a storage module to store the standard 3D model.

3. The surveillance system of claim 1, wherein the standard 3D model is obtained by the TOF camera capturing the scene when there is no anomalous event occurring in the scene.

4. The surveillance system of claim 1, wherein the 3D model module obtains a curved surface according to the distance data between the plurality of points in the scene and the TOF camera, to obtain the 3D model of the scene.

5. The surveillance system of claim 4, wherein the comparing module compares two curved surfaces according to the two 3D models, to determine whether the two 3D models are the same.

6. A surveillance method comprising:
capturing a scene by a time-of-flight (TOF) camera to obtain an image of the scene and distance data between a plurality of points in the scene and the TOF camera;
obtaining a three-dimensional (3D) model of the scene according to the image and the distance data;
comparing the 3D model with a standard 3D model to determine whether the two 3D models are the same; and
noticing that there is anomalous event occurring in the scene upon the condition that the two 3D models are different.

7. The surveillance method of claim 6, wherein the standard 3D model is obtained by the TOF camera capturing the scene when there is no anomalous event occurring in the scene.

8. The surveillance method of claim 6, wherein the 3D model is obtained from a curved surface according to the distance data between the plurality of points in the scene and the TOF camera.

9. The surveillance method of claim 8, wherein the step of comparing the 3D model with a standard 3D model to determine whether the two 3D models are the same comprises:
comparing two curved surfaces according to the two 3D models to determine whether the two 3D models are the same.
